(19) United States
(12) Patent Application Publication
(10) Pub. No.: US 2025/0165320 A1
(43) Pub. Date: May 22, 2025

(54) SYSTEM AND METHOD FOR ACCESSING OBJECT STORES

(71) Applicant: Nutanix, Inc., San Jose, CA (US)

(72) Inventors: Aafreen Sheik, Bengaluru (IN); Sachin Lokulwar, Bengaluru (IN); Satyendra Singh Naruka, Bengaluru (IN); Xuerong Hu, San Jose, CA (US); Ashish Anil Kale, Pune (IN)

(73) Assignee: Nutanix, Inc., San Jose, CA (US)

(21) Appl. No.: 18/745,874

(22) Filed: Jun. 17, 2024

(30) Foreign Application Priority Data
Nov. 16, 2023 (IN) 202341077822

(51) Int. Cl. G06F 9/54

(52) U.S. Cl. CPC G06F 9/548

(57) ABSTRACT

A system and method for implementing an objects browser service is disclosed. The system and method include receiving, from a web browser of a user device, a first API call to access a first object in a first object store hosted on a public cloud, in response to the first API call, making a second API call to the first object store to transmit the first object to the user device, receiving, from the web browser of the user device, a third API call to access a second object in a second object store hosted in an on-premises system, and, in response to the third API call, making a fourth API call to the second object store to transmit the second object to the user device.

### CROSS-REFERENCE TO RELATED APPLICATIONS

This application claims priority to Indian Provisional Application No. 202341077822, filed Nov. 16, 2023, which application is incorporated herein by reference in its entirety.

### BACKGROUND

Object storage treats data as discrete units, or objects, that are accompanied by metadata and a universally unique identifier (UUID). This unstructured data resides in a flat (as opposed to tiered) address space called a storage pool.

### SUMMARY

Aspects of the present disclosure relate generally to object storage, and more particularly to a system and method for accessing object stores.

In some aspects, a system is disclosed. The system includes one or more memories having computer-readable instructions stored thereon and one or more processors of an objects browser that executes the computer-readable instructions to receive a user request via a user interface of an objects browser to perform an operation on an object store, the request comprising an access token, determine that the access token is unexpired, responsive to determining that the access token is unexpired, determine a secret key associated with the access token, and transmit a first Application Programming Interface (API) request to the object store, the API request comprising a signature generated based at least on the secret key and requesting the operation to be performed on the object store.

In some aspects, a system is disclosed. The system includes one or more memories having computer-readable instructions stored thereon and one or more processors of an objects browser that executes the computer-readable instructions to receive a user request via a user interface of an objects browser to perform an operation on an object store, the request comprising a first access token, determine that the first access token is expired, determine that a refresh token associated with the first access token is unexpired, generate a second access token or renew the first access token as the second access token responsive to determining that the refresh token is unexpired, determine a secret key associated with the second access token, and transmit a first Application Programming Interface (API) request to the object store, the API request requesting the operation to be performed on the object store.

In some aspects, a system is disclosed. The system includes one or more memories having computer-readable instructions stored thereon and one or more processors of an objects browser that executes the computer-readable instructions to receive a user request via a user interface of an objects browser to upload an object to an object store, update a Cross-Origin Resource Sharing (CORS) rule at the object store, generate a pre-signed Uniform Resource Locator (URL) upon updating the CORS rule at the object store, send the pre-signed URL to the user interface of the objects browser, wherein the objects browser uploads the object directly to the object store using the pre-signed URL, receive a message via the user interface of the objects browser that the upload of the object is complete, and reset the CORS rule at the object store.

Further details of aspects, objects, and advantages of the disclosure are described below in the detailed description, drawings, and claims. Both the foregoing general description and the following detailed description are examples and are not intended to be limiting as to the scope of the disclosure. Particular embodiments may include all, some, or none of the components, elements, features, functions, operations, or steps of the embodiments disclosed above. The subject matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 is an example block diagram for accessing object stores.

FIG. 2 is an example swim lane diagram for accessing an object store in FIG. 1.

FIG. 3 is an example flow chart outlining operations for accessing an object store in FIG. 1.

FIG. 4 is an example flow diagram outlining operations for uploading an object to an object store in FIG. 1.

FIG. 5 is an example flow diagram outlining operations for accessing objects in different object stores.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

An object store is an architecture for managing unstructured data. An object store may be provided by a software defined object service. In some implementations, the service may be designed with an Amazon Web Services (AWS) Simple Storage Service (AWS S3) compatible REST Application Programming Interface (API) capable of handling unstructured and machine-generated data. In some implementations, the service may be designed with a different, non-S3 compatible API. In some implementations, the service may be designed to interface with S3 compliant data stores and non-S3 compliant data stores. The service may be deployed and managed as part of an enterprise cloud system. The service may enable users to store and manage unstructured data on top of a highly scalable hyper converged platform. The service may provide a cloud-hosted solution or an on-premise hosted solution, or a combination thereof. An object store may be used for a variety of purposes. For example, an object store may be used for backup to protect data with a simple, scalable, and cost-effective active archive solution. The object store may be used for long-term retention of data, providing easy development access to data using simple API commands, etc. An object store may include one or more buckets. Each bucket may be configured to store unstructured data. Each piece of data in a bucket may be called an object.

An object store may be a single object store (also called a single object store instance) or be part of a federation. When part of a federation, a single uniform namespace (e.g., filename or address) may allow multiple independent object stores to share a common namespace or naming system and to refer to the same resources (e.g., object store instances) using the same names, even if those resources are located in a different systems and locations. Thus, federation may provide a way to create a single namespace across multiple individual object store instances and access the multiple individual object store instances using the single namespace.

Object stores may be accessed in many ways. There is no standard way for accessing different object stores even if the underlying protocol (e.g., S3) is the same. Different S3 compliant (and non-S3 compliant) object stores may have different mechanisms to access those object stores. For example, some object stores, whether single or part of a federation, may be accessed using an objects browser. An objects browser may be a web-based user interface to access and perform operations on any object store by utilizing API requests. Other object stores may be accessed using an S3 console instead of an objects browser. Object stores may be accessed in other ways as well. These different mechanisms of access cause confusion, increase complexity, and make accessing the object stores less user friendly. A user desiring access to object stores configured with different types of access may be required to keep track and implement the different access mechanisms to operate/manage the different object stores.

The present disclosure provides a Software as a Service (SaaS) based objects browser service which can be used to access different object stores. For example, the objects browser service of the present disclosure may be used to access any S3 compliant object store even if those object stores are configured for different types of access. Thus, the objects browser service of the present disclosure provides a uniform method of accessing object stores. The objects browser service may also be used to access non-S3 compliant object stores. The objects browser service may include a client-side component (e.g., a user interface of a web browser) and a server-side component that provide a highly scalable solution to access various object stores.

The objects browser service of the present disclosure provides a token-based session access to increase security and reduce complexity of accessing object stores. S3 based object stores rely on an access key and secret key (e.g., credentials) to authenticate a user before providing access to an object store. This requires the user to remember the access key and the secret key each time access to an object store is desired. Further, the access key and the secret key may be stored on the client side, posing a security risk. The objects browser service of the present disclosure may use an access token to provide access to an S3-compliant object store (e.g., AWS) or a non-S3 compliant object store (e.g., AZURE, GOOGLE CLOUD). The objects browser service may use another access protocol to access a non-S3 compliant object store. The access token may be generated as part of a sign in process based on an access key and secret key associated with the user. Subsequent operations on the object store may be performed using the access token without needing the access key and secret key, thereby avoiding the need to store the access key and the secret key on the client side. Thus, the access token greatly simplifies access to object stores by abstracting the signing process from the user.

The objects browser service of the present disclosure may also be used for scalable uploads directly to the object store. In particular, the present disclosure provides a multiple part upload approach to any object store using the objects browser service via a web browser (e.g., the objects browser). Scalable uploads are complex, requiring either command line interface (CLI) based tools or are limited by the sizes imposed by the web-based solutions. For example, the AWS S3 console imposes an upper limit of 160 GB, meaning that objects greater in size than 160 GB may not be uploaded. The present disclosure allows uploading large objects (e.g., as large as 10 TB) by using the objects browser service. The objects browser service allows the objects browser to communicate directly with the object store instead of routing the object through the objects browser service, thereby saving network bandwidth and reducing latency of upload.

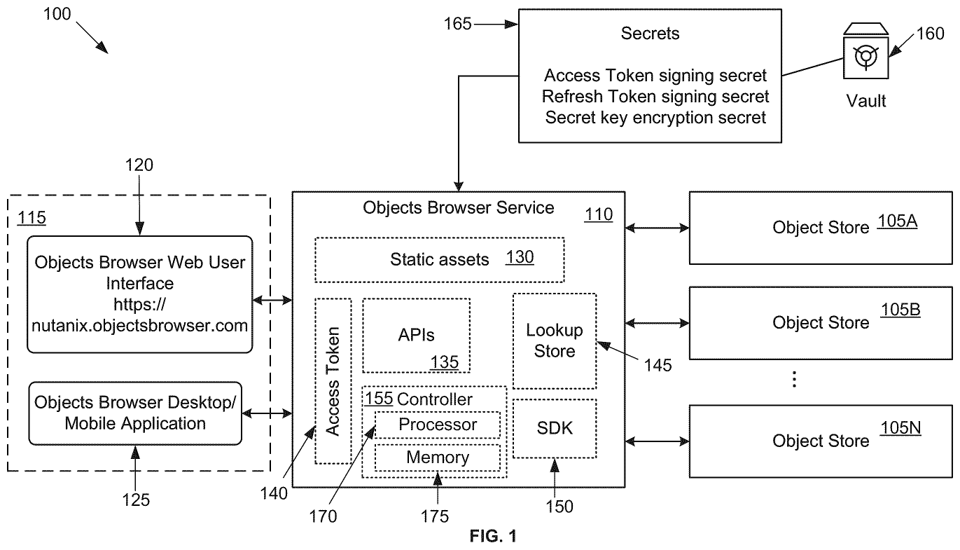

FIG. 1 is an example block diagram of an object store system 100. The object store system 100 may be used to access one or more object stores 105A-105N (collectively referred to as object stores 105 and singularly referred to as object store 105). The object stores 105 may be accessed using an objects browser service 110. Although three object stores are shown in FIG. 1, in other embodiments, greater than or fewer than three object stores may be in communication with the objects browser service 110. The object stores 105 may include any of a variety of object stores. For example, in some embodiments, one or more of the object stores 105 may be on-premise based object stores. In some embodiments, one or more of the object stores 105 may be cloud based object stores. In some embodiments, one or more of the object stores 105 may be hybrid cloud based object stores. In some embodiments, one or more of the object stores 105 may be S3 compliant object stores. In some embodiments, one or more of the object stores 105 may be non-S3 compliant object stores. In some embodiments, one or more of the object stores may be part of a federation.

Each of the object stores 105 may be a logical or physical construct for storing objects (e.g., immutable data, unstructured data, etc.). Each of the object stores 105 may be hosted on a different host (e.g., node, host machine, physical host machine, server, server machine, etc.). For example, the object store 105A may be hosted on a first host, the object store 105B may be hosted on a second host, and the object store 105N may be hosted on a third host. In some embodiments, multiple object stores may be hosted on a single host. Each of the object stores 105 may include one or more buckets. Operations may be performed on the buckets. Bucket operations may include, but are not limited to, listing of buckets and objects, viewing and updating buckets, and/or object parameters (versioning, write-once-read-only (WORM), lifecycle, replication, etc.). Each of the buckets include objects. Objects are discrete units of data that are stored in a structurally flat data environment. There may not be folders, directories, or complex hierarchies as in a file-based system. Each object may be a self-contained repository that includes the data, metadata (descriptive information associated with an object), and a unique identifying ID number (instead of a file name and file path). An object may be considered immutable data. Each of the object stores 105 may include one or more namespaces. Namespace may include buckets and then objects within those buckets.

The objects browser service 110 may be accessed via an objects browser 115. The objects browser 115 may form the front end of the objects browser service 110. A user may be able to launch the objects browser 115 from any of the object stores 105 or any computing device capable of connecting to the object stores. The objects browser 115 may provide a user interface that allows a user to directly launch an object store (e.g., the object stores 105). The objects browser 115 may be implemented in the form of a web user interface 120 or a desktop/mobile application 125. The web user interface 120 of the objects browser 115 may allow access to the objects browser service 110 using a web browser. For example, the web user interface 120 may allow a user to directly launch an object store (e.g., the object stores 105) in a web browser using a Uniform Resource Locator (URL). The user may open a web browser in a computing device (e.g., laptop) and enter a URL (e.g., https://nutanix.objectsbrowser.com) in an address bar of the web browser to access the objects browser 115. In some implementations, the URL to access the objects browser 115 may also include an identity of the object store 105 to access. For example, if the object store name is “objstoretest” and domain name is “nutanix.com,” the URL may include a Fully Qualified Domain Name (FQDN) for that object store. The FQDN may be “objstoretest.nutanix.com” (e.g., object store name+domain name). A path-based URL for accessing the objects browser 115 user interface may be “https://objstoretest.nutanix.com/objectsbrowser.” In some embodiments, a virtual URL may be used for accessing the objects browser 115: “https://objectsbrowser.objstoretest.nutanix.com.” In some embodiments, a path-based URL may be preferred due to cross-origin resource sharing (CORS) configurations. In some implementations, the objects browser 115 is served directly using a dedicated URL and does not require a path-based URL. The dedicated URL can be an arbitrary URL based on where the objects browser 115 is hosted.

The desktop/mobile application 125 may provide an alternate way of accessing the objects browser service 110 by a user. In some embodiments, a user may download a mobile or desktop software application of the objects browser 115 on a mobile device or a desktop device, respectively. Using the software application, the user may access the objects browser 115 and the object stores 105. By accessing the objects browser service 110 via either the web user interface 120 or the desktop/mobile application 125, the objects browser may allow a user to access and perform operations or otherwise manage the object stores 105.

The objects browser service 110 may include static assets 130, APIs 135, an access token 140, a lookup store 145, a Software Development Kit (SDK) 150, and a controller 155. The static assets 130 include assets of the web user interface (e.g., HTML, Cascading Style Sheets (CSS), javascript, images, fonts, etc.) which are served by the objects browser service 110 when a user accesses the objects browser using the web user interface 120. For example, when a user launches the objects browser 115 using a URL (e.g., https://nutanix.objectsbrowser.com), a message is sent to the static assets 130. The static assets 130 return the features to be displayed on a webpage of the objects browser. In other words, the static assets 130 render the webpage on the web user interface 120. For example, the static assets 130 may cause a login page to be displayed requesting user authentication credentials when the user enters the URL of the objects browser 115. The static assets 130 may be considered unauthenticated assets since a user has not been authenticated yet.

In some embodiments, the homepage of the objects browser 115 may present general information in a “public view.” A “view” may define the user interface components, pages, and related assets such as, images, etc. Depending on the level of access of the user, the views may be either a public view or an authenticated or private view. A public view may include views that do not require user authentication and may be accessed publicly by any user. The user may login into the objects browser 115 to view the authenticated view. The authenticated view may be a view that may be accessed by a user after authentication. For example, after a user logs into the objects browser 115 using a username/password, access key, secret key, or another type of authentication, (i.e., credentials) the user may access the authenticated view. Without the proper authentication credentials, the user may be prevented from seeing the authenticated view. In addition to the information accessible through the public view, the authenticated view may also provide access to object store details of one or more object stores (e.g., the object stores 105), bucket details of one of more buckets in the object stores (e.g., the buckets in the object stores 105), modal views such as static website, feature, etc.

The APIs 135 may be used for performing specific operations, such as listing the buckets, creating a bucket, uploading an object, etc. on the object stores 105. In some embodiments, the APIs 135 may be considered authenticated resources since the APIs may only be used after a user is successfully authenticated. The APIs 135 may use the SDK 150 to make API calls to the object stores 105. The objects browser 115 may call the APIs 135, causing the APIs 135 to use the SDK 150 to make API calls to the object stores 105. In particular, the SDK 150 (e.g., a JavaScript SDK) may be considered an API client responsible for initializing and calling the specific APIs (e.g., S3 APIs, Azure APIs, GCP APIs, etc.) 135. In some implementations, the SDK 150 may be a singleton module. The APIs may use the SDK 150 to make calls to the object stores 105. The SDK 150 may wrap the common features required by the specific APIs 135 and provide a base infrastructure to invoke them when needed by specific workflows. In this way, the APIs 135 can use the SDK 150 to make API calls to a plurality of object stores with different API formats. In an example, the SDK 150 includes a first set of APIs for a first object store and a second set of APIs for a second object store, allowing the APIs 135, using the SDK 150, to use the first set of APIs in response to a request from the objects browser 115 to access the first object store and to use the second set of APIs in response to a request from the objects browser 115 to access the second object store.

For example, when an API call (also referred to herein as API request) is to be made to the object stores 105, the SDK 150 may receive a user's secret key from the lookup store 145. The SDK 150 may then generate a signature using the secret key. The signature may be appended to the API request to the object stores 105. The SDK 150 may also be aware of the endpoint (e.g., the object store to be accessed and the location where the object store is hosted). The SDK 150 may generate the actual API request to the object store by utilizing the details from the lookup store 145 and the APIs 135. The SDK 150 may determine an identity of the objects store and/or a type of object store (e.g., S3 compliant, non-S3 compliant) to generate the actual SPI request to the object store. The SDK 150 may generate the “payload” of the API request in a compatible format (e.g., S3 format, non-S3 format) for specific operations to be performed on the object stores 105, generate a signature (e.g., from the secret key obtained from the lookup store 145) for the API request, and send the request to the relevant endpoint (e.g., object store). The SDK 150 may parse the request from JSON to XML before sending the actual API request to the endpoint. The SDK 150 may also parse the response (e.g., XML response) received from the endpoint (e.g., the object stores 105) to JSON and send the response back to the controller 155 for sending to the user. The controller 155 may further process the response (e.g., remove any unwanted data, aggregate with another response, generate user interface specific error messages without revealing internal details of the system, etc.) before sending to the user. The SDK 150 is, thus, responsible for handling the request payload creation, signing the requests and response transformation for user interface consumption, etc. In this way, the SDK 150 translates requests (i.e., API calls) from the objects browser 115 into requests (i.e., API calls) to the object stores 105 and translates responses from the object stores 105 into responses for the objects browser 115. The objects browser 115 may use a unified set of APIs (e.g., the APIs 135) for making requests to the object stores which are translated by the objects browser service 110 (e.g., the SDK 150) into API calls compatible with the different object store types (e.g., S3 compliant, non-S3 compliant) of the object stores 105. In this way, the objects browser 115 may use the same API call for requesting objects from different object stores, specifying the different objects, and the objects browser service 110 translates the same API call into object-store-specific API calls to the object stores 105. For example, upon successful authentication, if a user desires to list the buckets, the SDK 150 may perform the following steps:

The SDK 150 may add necessary parameters in the request body (e.g., in case of POST, PUT methods). The APIs 135 may include an extendible markup language (XML) string in the request payload. The SDK 150 may take care of transforming the JSON payload and convert the payload into the XML string understood by the API (e.g., S3) server (when applicable).

The SDK 150 may generate a v4 signature for the request and add it as part of request header “Authorization.”

The SDK 150 may use the underlying platform (e.g., the web browser from which the objects browser 115 is accessed) to make an API call using fetch and get the XML string response.

The SDK 150 may determine if the endpoint (e.g., S3 endpoint) is present in the underlying request and add the endpoint to the API call.

The SDK 150 may parse the XML string response into json and return back to the objects browser 115.

The SDK 150 may similarly make other API calls. Thus, the SDK 150 may communicate with the object stores 105 (e.g., make API calls to the object stores and receive responses back from the object stores).

The access token 140 protects the APIs 135. The access token 140 may be a JWT (JSON Web Token). The access token 140 may provide authentication to the APIs 135. In particular, the access token 140 needs to be unexpired to make an API call to access the object stores 105. The access token 140 may be short lived (e.g., 15-minute duration). Each time a user logs in for a new session, a new access token may be created. If a user is idle in an existing session for longer than a predetermined time (e.g., time past the duration of expiration of the access token), a new access token may be issued. In some embodiments, if the predetermined time has passed in a session, the access token 140 may be renewed. The access token 140 may provide access to the object stores 105. The access token 140 may be a random string, which may be associated by objects browser service 110 with an access key and secret key, which may then be used by the objects browser service to access the various object stores 105 via the SDK 150. Each access token 140 may have a corresponding mapping with an access key and a secret key that is stored in the lookup store 145. The access token 140 is not stored on the client side (e.g., the objects browser 115). When a user logs in (e.g., provides username/password), a unique access token 140 may be generated that may be active for a limited period of time. The access token 140 may be associated on the client side with an HTTP cookie. In this way, requests from the objects browser 115 including the cookie can be identified as requests calling for use of the access token 140.

The access token 140 may be included in user requests after generation. Thus, the user need not provide the access key and secret key each time the object stores 105 are to be accessed. If a user interface passes the access token 140 in a user request (e.g., using an HTTPS cookie or authorization header), the objects browser service 110 may accept the user request as authentic and provide access to the object store 105. If the access token 140 is missing or expired, the objects browser service 110 (and specifically the controller 155) intercepts the request and either returns a status message indicating denial (e.g., access denied/token expired) or, if a refresh token is still valid (e.g., as confirmed from the lookup store 145), automatically regenerate a new access token or renew the previous access token, and stamp the response with the regenerated/renewed access token to continue the session. In case both the access token and the refresh token are expired, the objects browser service 110 (and specifically the controller 155) denies access to the object stores 105 and requests the user to re-enter the login details.

The lookup store 145 may be considered a long-term cache or repository that stores a mapping between each user's access token 140 and the user's secret key. The lookup store 145 may also store the access key. By keeping track of the secret key via the mapping, the objects browser service 110 may avoid requesting the secret key from the user each time the user desires to access the object stores 105 so long as either the access token 140 or a refresh token associated with the access token is active. The mapping may allow the objects browser service 110 to determine an identity of the object store of the object store 105 to be accessed. The lookup store 145 may include a persistent storage (e.g., a database). The lookup store 145 may also store an encrypted secret key in addition to the access token 140 and the refresh token. The lookup store 145 may store other user related information. The lookup store 145 may be used by the SDK 150 to get details like the secret key to generate an API request (e.g., S3 request) to a specific object store endpoint (e.g., the object store 105). The lookup store 145 may include any database such as a MongoDB, etc., a filesystem based database, a centralized long term cache, etc.

As indicated above, each access token may be associated with a refresh token. When the access token 140 is generated, an associated refresh token for that access token is also generated. The access token 140 may have a shorter duration (e.g., 15 minutes), while a refresh token may have a longer duration (e.g., 1 week). The refresh token, similar to the access token 140, may be a JSON Web Token and may include a random string. By virtue of having different expiration durations, the access token 140 may expire before the refresh token. The refresh token may be stored within the lookup store 145 and associated with the access token 140 in a mapping. When the access token 140 is expired, the controller 155 may determine if the access token has a corresponding refresh token that is still active (e.g., unexpired). If the refresh token is active, the controller 155 may generate a new access token to replace the expired access token or renew the expired token with a new expiration period (e.g., another 15 minutes). If the refresh token is expired, the controller 155 may not renew the expired access token or generate a new access token. Instead, the controller 155 may send a message back to the user requesting the user to log in again to authenticate the user. Once the user is authenticated again, the controller 155 may generate another access token 140 (and an associated refresh token) for the user.

The object store system 100 also includes a vault 160. The vault 160 may represent a storage for storing secret values 165 (e.g., strings) that may be used to encrypt/decrypt information handled by the objects browser service 110. The objects browser service 110 may load the secret values from the vault 160 at the time of deployment of the objects browser service. In some embodiments, the vault may be configured to store three types of secret values:
1) Access token Signing secret: This secret string is used for signing and encrypting/decrypting the access token.
2) Refresh token signing secret: This secret string is used for signing and encrypting/decrypting the refresh token
3) Secret key encryption secret: This secret string is used to encrypt the secret key (which the user enters during login) and then persists the same in the lookup store 145 for further use.

The vault may be configured to store other or additional secret values.

The controller 155 of the objects browser service 110 may be associated with a processor 170 and a memory 175. The processor 170 may execute one or more instructions associated with the objects browser service 110. The processor 170 may include an electronic processor, an integrated circuit, or the like including one or more of digital logic, analog logic, digital sensors, analog sensors, communication buses, volatile memory, nonvolatile memory, and the like. The processor 170 may include, but is not limited to, at least one microcontroller unit (MCU), microprocessor unit (MPU), central processing unit (CPU), graphics processing unit (GPU), physics processing unit (PPU), embedded controller (EC), or the like. The processor 170 may include, or be associated with, the memory 175 operable to store or storing one or more non-transitory computer-readable instructions for operating components of the system processor and operating components operably coupled to the system processor. The one or more instructions may include at least one of firmware, software, hardware, operating systems, embedded operating systems, and the like. The processor 170 or the objects browser service 110 generally may include at least one communication bus controller to effect communication between the system processor and the other elements of the objects browser service 110.

The memory 175 may include one or more hardware memory devices to store binary data, digital data, or the like. The memory 175 may include one or more electrical components, electronic components, programmable electronic components, reprogrammable electronic components, integrated circuits, semiconductor devices, flip flops, arithmetic units, or the like. The memory 175 may include at least one of a non-volatile memory device, a solid-state memory device, a flash memory device, a NAND memory device, a volatile memory device, etc. The memory 175 may include one or more addressable memory regions disposed on one or more physical memory arrays.

The various communications in the objects browser service 110 may occur over a network. The network may be any type or form of network. The geographical scope of the network may vary widely and may include a body area network (BAN), a personal area network (PAN), a local-area network (LAN) (e.g., Intranet), a metropolitan area network (MAN), a wide area network (WAN), or the Internet. The topology of the network may assume any form such as point-to-point, bus, star, ring, mesh, tree, etc. The network may utilize different techniques and layers or stacks of protocols, including, for example, the Ethernet protocol, the internet protocol suite (TCP/IP), the ATM (Asynchronous Transfer Mode) technique, the SONET (Synchronous Optical Networking) protocol, the SDH (Synchronous Digital Hierarchy) protocol, etc. The TCP/IP internet protocol suite may include application layer, transport layer, internet layer (including, e.g., IPv6), or the link layer. The network may be a type of a broadcast network, a telecommunications network, a data communication network, a computer network, a Bluetooth network, or other types of suitable wired and wireless networks.

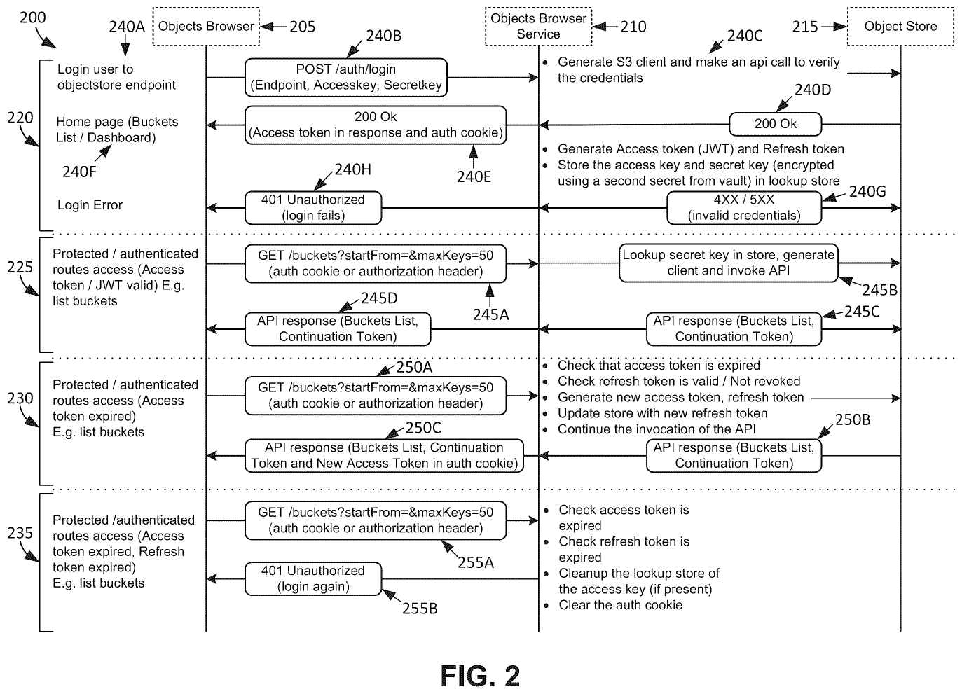

Turning to FIG. 2, an example swim lane diagram of a process 200 is shown, in accordance with some embodiments. The process 200 outlines the communications between an objects browser 205, an objects browser service 210, and an object store 215. The objects browser 205 is analogous to the objects browser 115, the objects browser service 210 is analogous to the objects browser service 110, and the object store 215 is analogous to the object store 105. The process 200 may include other or additional communication operations depending upon the embodiment. The process 200 is described with respect to an operation for listing the buckets in the object store 215. However, the process 200 may be used for other operations on the object store 215 as well in a similar fashion.

The process 200 shows a communication sequence 220 during authentication of a user, a communication sequence 225 for performing an operation on the object store 215 when the access token (e.g., the access token 140) is active (e.g., unexpired), a communication sequence 230 for performing an operation on the object store when the access token is expired but the refresh token is unexpired, and a communication sequence 235 when both the access token and the refresh tokens are expired.

The communication sequence 220 begins when a user desires to access the object store 215 (e.g., to perform an operation on the object store). The user may navigate to the objects browser 205 (e.g., by entering a URL using the web user interface 120 or accessing the objects browser desktop/mobile application 125). The URL may include the endpoint (e.g., location and/or identity of the object store 215 to be accessed). The objects browser 205 may send a message to the static assets 130 (either directly or via the controller 155) when the user navigates to the objects browser 205 using the web user interface 120 and render a webpage of the objects browser that may display a login page requesting authentication credentials from the user. Alternatively, if using the objects browser desktop/mobile application 125, upon launching the objects browser desktop/mobile application, the login page may be displayed. The user may enter their authentication credentials, as indicated at operation 240A. The authentication credentials may include a username, password, and any other desired information. For example, the user may also be requested to enter the secret key and the access key. The objects browser 205 transmits the authentication credentials and the endpoint (e.g., from the URL) using an unauthenticated API request 240B to the objects browser service 210.

Upon receiving the API request 240B, the objects browser service 210 (and particularly the controller 155 of the objects browser service) takes actions 240C. For example, the objects browser service 210 generates an API request to the object store 215 to verify the authentication credentials of the user. In particular, the SDK 150 of the objects browser service 210 may generate an API request using an unauthenticated API. The SDK 150 may transmit the API request to the object store 215. The object store 215, upon receiving the API request from the SDK 150, verifies the authentication credentials. For example, the object store 215 may invoke an API (e.g., S3 API) to validate the access key and secret key for the specified endpoint as follows:
GET https://endpoint_fqdn_or_ip/?max-keys=1
amz-sdk-invocation-id: ba2d533c-de16-43e3-b1c9-1b73814bOc0a
amz-sdk-request: attempt=1; max=3
authorization: AWS4-HMAC-SHA256 Credential=abc/20230822/us-east-1/s3/aws4_request, SignedHeaders=amz-sdk-invocation-id;amz-sdk-request;host;x-amz-content-sha256;x-amz-date;x-amz-user-agent, Signature=ea96d8db2ea14d14c80ee8693da08504d7796192d0a40f7c4edOfbe050e83dOd
x-amz-content-sha256: e3b0c44298fc1c149afbf4c8996fb92427ae41e4649b934ca495991b7852b855
x-amz-date: 20230822T072803Z
x-amz-user-agent: objects-browser-sdk/5.3.2

If the authentication credentials are valid (e.g., the keys are correct), the object store 215 returns an authentication successful message (e.g., sends an HTTPS status code, for example, 200Ok) 240D back to the objects browser service 210 (and particularly to the SDK 150 of the objects browser service). If the access and secret keys are correct, then the signature (e.g., the V4 signature) generated by SDK 150 may be considered valid and a following API may return an HTTP status code indicating successful authentication. The message 240D, in part, may look like:

```
<?xml version=“1.0” encoding=“UTF-8”?>
<ListAllMyBucketsResult xmlns=“http://s3.amazonaws.com/doc/2006-03-01/”>
  <Owner>
    <DisplayName>testuser@nutanix.com</DisplayName>
    <ID>51afc0f9-99f2-5849-b90b-799daf81b34b</ID>
  </Owner>
  <Buckets>
    ...
  </Buckets>
</ListAllMyBucketsResult>
```

The above message is for an operation of listing the buckets in the object store 215. However, similar messages may be generated for other types of operations. The SDK 150, upon receiving confirmation of the validity of the authentication credentials, may send the received message to the controller 155, which then sends a message 240E to the user indicating that the authentication was successful. The controller 155 may store the credentials (e.g., access key and the secret key) in the lookup store 145. The controller 145 may encrypt the credentials (e.g., access key and/or the secret key) with the secret key encryption secret from the vault 160 before storing in the lookup store 145. The controller 155 may also generate and store the access token 140 and the refresh token associated with the access token in the lookup store 145. The controller may associate (e.g., map) the access token 140, the refresh token, the secret key, and the access key with each other. In some embodiments, the controller 155 may encrypt the access token 140 with the access token signing secret from the vault 160 and encrypt the refresh token using the refresh token signing secret from the vault before storing in the lookup store.

The controller 155 may utilize information from the message 240D (e.g., DisplayName, ID, etc.) to form the JWT payload of the access token 140. In some embodiments, JWT generation may be done when the access key and the secret key have been validated. The access token 140 may include the following information (header and payload):
Header: the header may specify the token type and signing algorithm to be used. As an example, JWT may be the token type and HMAC SHA256 may be the algorithm used for signing:

```
{
  “alg”: “HS256”,
  “typ”: “JWT”
}
```

The above json may be base64 encoded to get the header value.

Payload: payload may include details of the user with some additional data. Non-sensitive information may be stored using the payload, including endpoint, access key, and region. Secret key is not stored as part of the payload. An example payload may include:
endpoint: provided by the user during login time.
accessKey: provided by the user during login time.
displayName: returned by the object store 215 after successful login (e.g., in the message 240D).
Id: returned by the object store 215 after successful login (e.g., in the message 240D)
sub: standard field which represents a subject in JWT. In some embodiments, the standard field may be the user's access key value.
iat: timestamp of when the access token is issued (epoch)
exp: timestamp indicating when the access token expires (epoch)
Signature: the signature may include the following information:
Encoded header: This is the base64 encoded value of the header.
Encoded payload: This is base64 encoded value of the payload from the access token 140.
Secret string: This may be the secret key signing request from the vault 160. This secret key signing request may be used for creating the signature and also for verifying the signature later.
Algorithm specified by header: This is the algorithm specified in the header of the access token 140.

A non-limiting example of a signature may be: HMACSHA256(base64Encode(header)+“.”+base64Encode(payload), secret).

The access token may include other or additional information.

The access token may be considered a concatenation of the header, payload, and signature generated from the access key and secret key: Header.Payload.Signature. An example of the access token may be:

eyJhbGciOiJIUzI1NiIsInR5cCI6IkpXVCJ9.eyJlbmRwb2ludCI6Im9zdG9yZTEubnV0Y W5peC5jb20iLCJhY2Nlc3NLZXkiOiJ1c2VyX2FjY2Vzc19rZXkiLCJkaXNwbGF5TmFtZSI6In Rlc3R1c2VyQG51dGFuaXguY29tliwiaWQiOiJ1c2VyX21kIiwic3ViIjoidXNlcl9hY2Nlc3Nfa2V 5IiwiaWF0IjoxNjkzMzAyODg4LCJleHAiOjE2OTMzMDQ2ODh9.ykJo7iS-lbMllzCVrfBMG0aHLk187iWWhiCxy2enKUE

The above access token is simply an example and not intended to be limiting in any way. This access token may be used by the client (e.g., the web user interface 120 or the desktop/mobile application 125) to authenticate itself to the objects browser service 210 and provide information for performing a lookup operation in the lookup store 145 (e.g., the access token includes the access key and user ID which can be used to lookup secret key from lookup store) to invoke APIs to access the object store 215.

The controller 155 may include the access token 140 and the refresh token in the message sent to the user. The message may also include an Authorization cookie (“Auth cookie”) or authorization header generated by the controller 155. The Auth cookie contains the information about the access token 140 and the refresh token. Once the Auth cookie is generated, subsequent requests (e.g., HTTP requests or API requests) from the objects browser 205 (and particularly the web-based user interface 120) may be stamped with the Auth cookie to avoid entering the access key/secret key/endpoint again. In particular, the Auth cookie may represent an HTTP cookie which is set by the objects browser service 210 (and particularly by the controller 155) once the authentication credentials of the user are verified (e.g. during initial login or after the access token expires but while a valid refresh token is available). The HTTP cookie cannot be accessed or modified by a client-side code (e.g., javascript) in the objects browser 205 and is included by all the subsequent HTTP requests which are initiated by the authenticated objects browser. The objects browser service 210 may set the Auth cookie by sending the following example response header after successful authentication:

Set-Cookie: auth %3Dj %3A %7B %22token %22%3A %22eyJhbGciOiJIUzI1NiIsInR5cCI6lkpXVCJ9.eyJlbm Rwb2ludCI6IjEuMi4zLjQiLCJhY2Nlc3NLZXkiOiJleGFtcGxlLWFjY2VzcylrZXktdmFsdWUi LCJkaXNwbGF5TmFtZSI6InRlc3RzMUBhYmMuY29tIiwiaWQiOiJzb21lLXVlaWQtb2YtdX NlciIsInN1YiI6ImV4YW1wbGUtYWNjZXNzLWtleS12YWx1ZSIsImlhdCI6MTY5MzIxNDU wMSwiZXhwljoxNjkzMjE2MzAxfQ.x432BVQTUVLM86xdlUtaMdlVBxo-Oq334ZfsDSEOWmY %22%7D; Path=/; HttpOnly

The above response header is only an example and not intended to be limiting in any way. Subsequent user requests from the objects browser 205 to the objects browser service 210 may automatically include a stamp with the following example request header:

Cookie: auth %3Dj %3A %7B %22token %22%3A %22eyJhbGciOiJIUzI1NiIsInR5cCI6IkpXVCJ9.eyJlbm Rwb2ludCI6IjEuMi4zLjQiLCJhY2Nlc3NLZXkiOiJleGFtcGxlLWFjY2VzcylrZXktdmFsdWUi LCJkaXNwbGF5TmFtZSI6InRlc3RzMUBhYmMuY29tIiwiaWQiOiJzb211LXVlaWQtb2YtdX NlciIsInN1YiI6ImV4YW1wbGUtYWNjZXNzLWtleS12YWx1ZSIsImlhdCI6MTY5MzIxNDU wMSwiZXhwljoxNjkzMjE2MzAxfQ.x432BVQTUVLM86xdlUtaMdlVBxo-Oq334ZfsDSEOWmY %22%7D

The above request header is only an example and not intended to be limiting in any way.

If the user is using the desktop/mobile application 125, the objects browser service 210 (and particularly the controller 155) may generate the authorization header and send the header via the message 240E. The authorization header may include information about the access token 140. The authorization header may then be automatically included in future API requests from the desktop/mobile application 125 for accessing the object store 215. The authorization header may be in this format: Authorization: Bearer <token>. An example authorization header may have a value:

Authorization: Bearer eyJhbGciOiJIUzI1NiIsInR5cCI6IkpXVCJ9.eyJlbmRwb2ludCI6IjEuMi4zLjQiLCJhY2Nlc3NLZ XkiOiJleGFtcGxlLWFjY2VzcylrZXktdmFsdWUiLCJkaXNwbGF5TmFtZSI6InRlc3RzMUBh YmMuY29tIiwiaWQiOiJzb211LXV1aWQtb2YtdXNlciIsInN1YiI6ImV4YW1wbGUtYWNjZX NzLWtleS12YWx1ZSIsImlhdCI6MTY5MzIxNDUwMSwiZXhwIjoxNjkzMjE2MzAxfQ.x432B VQTUVLM86xdlUtaMdlVBxo-Oq334ZfsDSEOWmY

The above authorization token is only an example and not intended to be limiting in any way.

Upon receiving the message 240E, the objects browser 205 may display authenticated views 240F on the homepage. The authenticated views may allow the user to access the object store 215 for performing operations on the object store. On the other hand, if the object store 215 determines that the authentication credentials are invalid, the object store may send a message 240G indicating that the authentication failed. For example, the object store 215 may send an HTTP status code (e.g., 4xx/5xx) indicating that the authentication credentials are invalid. The SDK 150 of the objects browser service 210 receives the message 240G and transfers the message to the controller 155. The controller 155 generates a message 240H indicating that the authentication failed.

Upon successful authentication, the user may use the communication sequence 225 to perform an operation on the object store 215. The explanation below is with respect to listing the buckets in the object store 215 but may be used with other operations on the object store. After authentication, the SDK 150 uses protected APIs in communications with the object store 215. To list the buckets in the object store 215, upon successful authentication, the user, via a user interface (e.g., the web user interface 120 or the desktop/mobile application 125) of the objects browser 205, may send an API request 245A (i.e. API call) via the objects browser 205 to list the buckets of the object store 215. The objects browser 205 may automatically append the Auth cookie or authorization header to the API request 245A. The objects browser 205 may automatically append an identity of the object store 215 to the API request 245A. When the objects browser service 210 (and particularly the controller 155) receives the API request 245A, the controller validates the access token from the Auth cookie or the authorization header included in the API request 245A before doing any further processing. Validating the access token may include determining that the access token is not expired.

If the access token 140 is active (e.g., unexpired), the controller 155 of the objects browser service 210 maps the API request 245A to an API request 245B to the object store 215. In some implementations, mapping the API request 245A to the API request 245B includes mapping the access token 140 to the associated secret key from the lookup store 145. The objects browser service 210 may determine the identity of the object store 215 from the API request 245A. In an example, the objects browser service 210 determines the identity of the object store 215 from the API request 245A based on the identity of the object store 215 being included in the API request 245A. In an example, the objects browser service 210 determines the identity of the object store 215 from the API request 245A based on a mapping between the access token 140 to the object store 215. In some embodiments, the controller 155 may decrypt the access token 140 and the secret key. The controller 155 may send the secret key to the SDK 150 (or the SDK may retrieve the access key and secret key from the lookup store 145), which then generates a signature and appends the signature to the API request 245B to the object store 215. The SDK 150 generates the signature based on the object store 215. The SDK 150 may use an algorithm associated with the object store 215 for generating the signature. The SDK 150 may generate signatures to be appended to API requests to multiple different object stores, using different algorithms for different object stores. In an example, each object store is associated with its own standard signature algorithm which the SDK 150 uses for making API requests to the object store.

The object store 215 receives the API request 245B and sends a response message 245C back. The response message 245C may include the bucket list associated with object store 215. The objects browser service 210 (in particular the SDK 150) receives the message 245C and transmits that message to the controller 155. The controller 155 prepares a response message 245D and transmits that message to the user and displays the list of buckets on the user interface of the objects browser 205.

The communication sequence 230 starts with the user sending an API request 250A (i.e., API call) upon successful authentication in the communication sequence 220. The message 250A is similar to the API request 245A. The objects browser service 210 (in particular the controller 155) receives the API request 250A and determines if the access token 140 is still active. The API request 250A may be an API call made by the objects browser 205 to the objects browser service 210. The API call may include the access token 140 and/or an identity of the object store 215 to be accessed. Responsive to determining that the access token 140 has expired, the controller 155 determines if the refresh token associated with the access token 140 is active (e.g., unexpired/not revoked). If the refresh token is still active the controller 155 generates a new access token (or renews the expired access token). The controller 155 may also generate a new refresh token for the new access token. The controller 155 may update the lookup store 145 with the new access token and the new refresh token. In some embodiments, the controller 155 may delete the old access token 140 and the associated refresh token from the lookup store 145 and may replace those with the new access token and refresh token, respectively. The controller 155 may also associate the secret key associated with the old access token with the new access token. The controller may encrypt the new access token and the new refresh token before storing in the lookup store 145. Upon generating the new access token and the new refresh token, the controller 155 may request the SDK 150 to make an API request to the object store 215. The API request is similar to the API request 245B. The objects browser service 210 may map the API request 250A to the API request to the object store 215. The object store 215, upon receiving the API request, sends a response message 250B back to the SDK 150. The response message 250B is similar to the response message 245C. The SDK 150 transmits the response message 250B to the controller 155 which then transmits a message 250C to the objects browser 205. The response message 250C is similar to the response message 245D.

The communication sequence 235 may be followed when the access token 140 and the refresh token associated with the access token are both expired. The communication sequence 235 may begin with a user sending an API request 255A (i.e., API call) to the controller 155 of the objects browser service 210. The API request 255A is similar to the API request 245A. Upon receiving the API request 255A, the controller 155 determines that the access token 140 in the message 255A is expired. The controller 155 may also determine that the refresh token associated with the access token 140 is also expired. Thus, the controller 155 may prevent the user from accessing the object store 215. The controller 155 may generate a response message 255B denying access to the object store 215. The response message 255B may be transmitted to the objects browser 205 for display to the user. Additionally, the controller 155 may clean up the lookup store 145 by deleting the access token 140 that is expired, the associated token refresh token, the secret key, and the access key. The controller 155 may also clear the Auth cookie/authorization header. The user may be requested to perform the communication sequence 220 again to gain access to the object store 215.

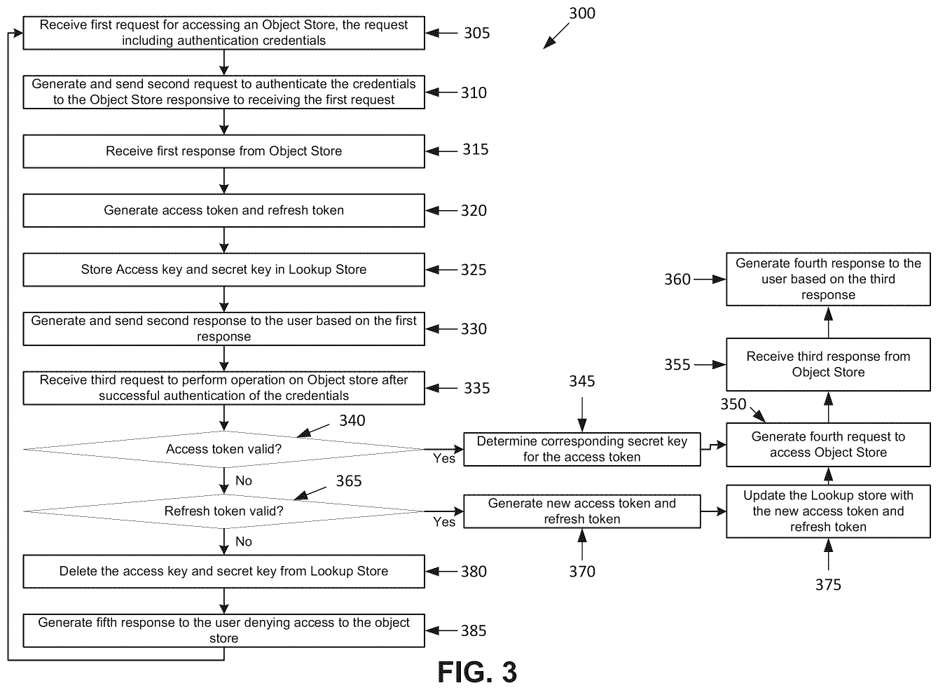

Turning to FIG. 3, an example flowchart outlining the operations of a process 300 is shown. The process 300 may be implemented by the objects browser service 110 to facilitate communication between the objects browser 115 and the object stores 105. The process 300 may include other or additional operations depending on the particular embodiment. The process 300 begins at operation 305 when the objects browser service 110 (and particularly the controller 155) receives a first request for accessing one of the object stores 105. The first request may include the authentication credentials of the user (e.g., username and/or password, the access key, and the secret key). The first request may be similar to the message 240B. At operation 310, the objects browser service 110 (and particularly the controller 155 and the SDK 150) generates an API request to the object store 105.

At operation 315, the objects browser service 110 (and particularly the SDK 150) receives a first response from the objects store 105. The first response may be similar to the message 240D or 240G. The SDK 150 transmits the first response to the controller 155. At operations 320 and 325, the objects browser service 110 (and particularly the controller 155) generates an access token and a refresh token and stores the access token and the refresh token into the lookup store 145 upon the first response indicating successful authentication (e.g., the message 240D). The controller 155 may also store the access key and secret key received at the operation 305 in the lookup store 145. At operation 330, the controller generates a second response message and sends the second response message for display on the objects browser 115. The second response message may be similar to the message 240E or 240H. For example, if the first response indicates successful authentication, the controller generates the second response message that is similar to the message 240E. On the other hand, if the first response indicates that authenticated failed, the controller 155 generates the second response message that is similar to the message 240H. The operation 325 is performed only when the authentication is successful (e.g., if the message 240D is received).

Assuming successful authentication of the user, at operation 335, the objects browser service 110 receives a third request to perform an operation on the objects store 105. The third request is similar to the API request 245A (although the third request may vary based on the type of operation being performed on the object store 105). Responsive to receiving the third request, the objects browser service 110 (and particularly the controller 155) determines at operation 340 whether the access token generated at the operation 315 is active (e.g., unexpired) or not. If the access token is active, then at operation 345, the controller 155 requests the SDK 150 to make an API call to the object store 105 upon validating the access token. The SDK 150 determines the secret key for the access token from the lookup store 145. At operation 350, the SDK 150 generates a fourth request to access the object store 105. The fourth request is similar to the message 245B.

At operation 355, the objects browser service 110 (and particularly the SDK 150) receives a third response back from the object store 105. The third response is similar to the message 245C. At operation 360, the controller 155 generates a fourth response based on the third response and sends the fourth response to the user for display on the objects browser 115. The fourth response is similar to the message 245D. To perform another operation on the object store 105, the process 300 may loop back to the operation 335.

If, at the operation 340, the controller 155 determines that the access token is not active (e.g., expired), the process 300 proceeds to operation 365. At the operation 365, the controller 155 determines if the refresh token associated with the access token is active or not. If the refresh token is active (e.g., unexpired), at operation 370, the controller 155 generates a new access token (or renews the old access token) and a new refresh token. The controller 155 updates the lookup store 145 with the new or renewed access token and the new refresh token at operation 375. The SDK 150 then generates the fourth request as discussed with respect to the operation 250 and receives the third response (e.g., the message 250B) from the objects store 105 as discussed with respect to the operation 355. The controller 155 generates the fourth response (e.g., the message 250C) at the operation 360, as discussed above.

If the refresh token is not active at the operation 365, the process 300 proceeds to operation 380 where the controller 155 denies access to the object store 105 and deletes the access key and secret key from the lookup store 145. At operation 385, the controller generates a fifth response to the user denying access to the object store 145. The fifth response is similar to the message 255B. The process 300 then loops back to the operation 305.

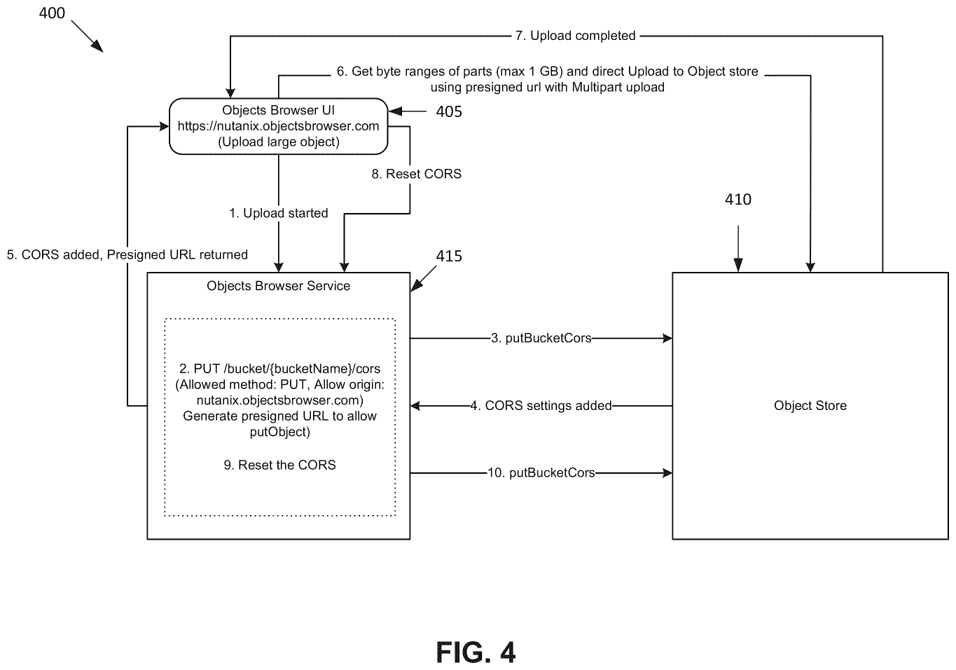

Now referring to FIG. 4, an example block diagram showing a process 400 for uploading an object to the object store 105 is shown, in accordance with some embodiments of the present disclosure. Specifically, object stores may be designed to handle very large uploads. However, uploading the very large objects to an object store may be challenging. Because of the large size of an upload, a proxy to upload the object to the object store may be desirable to avoid. The objects browser service 110 is configured to facilitate a direct upload from the objects browser 115 to the object store 105 without using a proxy. This direct upload not only saves time, it improves network latency and consumes less bandwidth. The objects browser service 110 acts as a mediator to allow these very large uploads directly from the objects browser 115 to the object store 105 using a multipart upload (also referred to herein as an upload in multiple parts). Each multipart upload may have a designated maximum size. Thus, for example to upload an object that is 1000 GB in size, with a maximum upload size of 1 GB, the 1000 GB object may be uploaded in multiple parts, with each part having a maximum size of 1 GB (thus using 10000 parts). Although FIG. 4 has been described in the context of uploading very large objects, FIG. 4 can be used for direct uploads of objects of any size.

The objects browser service 110 may help with setting up a CORS rule to allow upload from a different origin (e.g., the objects browser 115) to the object store 105 directly. The objects browser service 110 may also be configured to reset the CORS rule once the upload completes. The objects browser service 110 may generate a pre-signed URL to allow the objects browser 115 to directly upload the object to the object store 105 using APIs (e.g., PutObject) and download objects from the object store using APIs (e.g., GetObject).

The process 400 starts when a user desires to upload, via an objects browser 405, an object (e.g., a large object) to an object store 410. The objects browser 405 is similar to the objects browser 115 and the object store 410 is analogous to the object stores 105. At operation 1, the user begins the upload of the object via the objects browser 405. At the operation 1, the actual object is not uploaded. Rather, an intent message to upload the object to the object store 410 is sent to an objects browser service 415. The objects browser service 415 is analogous to the objects browser service 110. Once the objects browser service 415 receives the intent message, the objects browser service 415 updates a CORS rule for the underlying object store 410 to which the object is to be uploaded at operation 2. The CORS rule may allow an HTTP method PUT and indicate the origin of the upload (e.g., the location and/or identity of the objects browser 405). An example of the CORS rule (also referred to herein as a CORS setting) may be:

```
<?xml version=“1.0” encoding=“UTF-8”?>
<CORSConfiguration
xmlns=“http://s3.amazonaws.com/doc/2006-03-01/”>
      <CORSRule>
        <AllowedHeader>
    *
  </AllowedHeader>
          <AllowedMethod>
    PUT
  </AllowedMethod>
          <AllowedOrigin>
    https://nutanix.objectsbrowser.com
  </AllowedOrigin>
      </CORSRule>
</CORSConfiguration>
```

At operation 3, the objects browser service 415 adds the updated CORS rule to the object store 410. At operation 4, the objects browser service 415 receives a message from the object store 410 indicating that the CORS rule has been added. At operation 5, the objects browser service 415 generates a pre-signed URL and sends the pre-signed URL to the objects browser 405. The pre-signed URL may be valid for a predetermined period of time (e.g., 1 hour) for performing a specific operation (e.g., a putObject operation). A pre-signed URL may have all the information required to authenticate the objects browser 405 to the object store 410 (e.g., for signature (step 2, 5)). An example of a pre-signed URL may be:
https://ostore1.nutanix.com/test-bucket-1/test-obj1.txt?X-Amz-Algorithm=AWS4-HMAC-SHA256&X-Amz-Content-Sha256=UNSIGNED-PAYLOAD&X-Amz-Credential=dknc8UdZV7u9NUQ7iqcrr-KEqZVPpCaQ %2F20230829%2Fus-east-1%2Fs3%2Faws4_request&X-Amz-Date=20230829T100002Z&X-Amz-Expires=3600&X-Amz-Signature=fe7746030274e5ccad5a57b8a9704032c3c4d82e7cc1b24c0edd947b73a5989f&X-Amz-SignedHeaders=host&x-id=PutObject

Upon receiving the pre-signed URL, the objects browser 405 is ready to upload the object directly to the object store 410 using the pre-signed URL. At operation 6, the objects browser determines whether a multipart upload is needed to upload the object to the object store. Specifically, the objects browser 405 may determine the maximum upload size of each chunk of data that may be uploaded to the object store 410 at a time. For example, if the object size is 100 GB and the maximum upload size of each chunk 1 GB, the objects browser 405 may determine that the 100 GB object requires a multipart upload to the object store 410 because the size of the object is greater than the maximum upload size of each chunk. By dividing the size of the object with the maximum upload size, the objects browser 405 may determine the number of chunks that may be needed to upload the object fully to the object store 410. For example, by dividing 100 GB by 1 GB, the objects browser 405 may determine that the object requires a multipart upload of 100 chunks, with each chunk having a size of 1 GB. It is to be noted that the objects browser 405 only logically splits the object into multiple parts. The object is not physically split on the client side so that no additional storage requirement is needed on the client side. The object is split into multiple parts logically by determining the byte ranges that may be uploaded in each part.

The objects browser uploads each part one at a time directly to the objects store 410 using the pre-signed URL received at the operation 5. At operation 7, the objects store 410 sends a message back to the objects browser 405 directly indicating that the upload has been completed. In some embodiments, the message of the operation 7 may be sent when all of the chunks (e.g., 100 chunks in the example above) have been uploaded. In other embodiments, the message of the operation 7 may be sent each time a chunk of data is successfully uploaded. In such cases, the objects browser 405 may wait for the message of the operation 7 before uploading the next chunk.

Upon completing the upload of the object to the objects store 410, the objects browser 405 sends a message to the objects browser service 415 indicating that the upload has been completed and that the CORS rule may be reset at operation 8. Responsive to receiving the message of the operation 8, the objects browser service 415 resets the CORS rule at operation 9 and sends a message at operation 10 to the object store 410 to remove the CORS setting that was added at the operations 2-4. By using the CORS setting the objects browser service 415 allows the objects browser 405 to directly upload objects to the object store 410.

Downloads of data may be similarly performed directly from the object store 410 to the objects browser 405. For Downloads, the objects browser service 415 may generate a pre-signed URL for performing a download operation (e.g., a GetObject API call) and issue a native GET request from the objects browser 405. An example of the pre-signed URL may be:
https://ostore1.nutanix.com/test-bucket1/test-obj.txt?X-Amz-Algorithm=AWS4-HMAC-SHA256&X-Amz-Content-Sha256=UNSIGNED-PAYLOAD&X-Amz-Credential=dknc8UdZV7u9NUQ7iqcrr-KEqZVPpCaQ %2F20230829%2Fus-east-1%2Fs3%2Faws4_request&X-Amz-Date=20230829T095529Z&X-Amz-Expires=10&X-Amz-Signature=9e20a80dabd5e86cc532a80f25c874b22aa414a27443fab8341775cd078937el&X-Amz-SignedHeaders=host&response-content-disposition=attachment %3B %20filename %3D %22test-obj.txt %22&x-id=GetObject

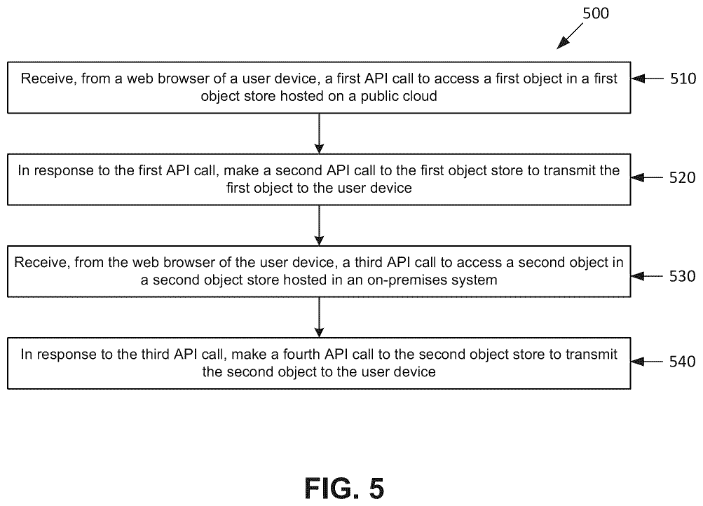

FIG. 5 is an example flow diagram outlining operations of a method 500 for accessing objects in different object stores. The method 500 may include more, fewer, or different operations than shown. The operations can be performed in the order shown, in a different order, or concurrently. The method 500 may be performed by the objects browser service 110 of FIG. 1.

At operation 510, a first API call to access a first object in a first object store hosted on a public cloud is received from a web browser of a user device. The first API call may be selected from a set of API calls. In some implementations, the first API call is an object request API call identifying the first object.

At operation 520, in response to the first API call, a second API call is made to the first object store to transmit the first object to the user device. In some implementations, transmitting the first object to the user device includes receiving the first object at the objects browser service and transmitting the first object from the objects browser service to the user device. In some implementations, transmitting the first object to the user device includes causing the object store to transmit the first object directly to the user device. Operations 510 and 520 are similar to the communications sequence 225 of FIG. 2.

In some implementations, the method 500 includes mapping the first API call to the second API call. In some implementations, the first API call is mapped to the second API call based on an object store of the first object store. In an example, the second API call is an S3 compliant API call, and the first API call is mapped to the second API call based on the first object store being an S3 compliant object store. In some implementations, the method 500 includes mapping an access token of the first API call to the second API call based on an object store type of the first object store. The access token may correspond to credentials of the first object store, the credentials stored by the objects browser service. In this way, the web browser does not have to use or store the credentials to access the first object store. The access token can be implemented as a cookie in the first API call, as discussed herein.

In some implementations, the method 500 includes receiving, from the first object store, a first API response and sending the first API response to the web browser of the user device. The first API response may include the object. The first API response may include an identifier of the object or a location of the object. In an example, the first API response includes an identifier of a bucket where the object is located. In some implementations, the method 500 includes receiving, from the first object store, the first API response and generating, based on the first API response, a second API response to send to the web browser. The second API response may have a standardized format that the objects browser service uses for serving API responses to the web browser. By generating new API responses based on the received API responses, API responses from various different object stores can be served to the web browser in the standardized format.

At operation 530, a third API call to access a second object in a second object store hosted in an on-premises system is received from a web browser of a user device. The third API call may be selected from the set of API calls. In some implementations, the third API call is an object request API call identifying the first object. In some implementations, the first API call and the third API include a same header, and the first API call includes a payload identifying the first object store, and wherein the third API call includes a payload identifying the second object store. The payloads may be payloads of access tokens included in the API calls, as discussed herein.

At operation 540, in response to the third API call, a fourth API call is made to the second object store to transmit the second object to the user device. Similar to the relationship between the first API call and the second API call, the third API call may be mapped to the fourth API call. While the first API call and the third API call may be very similar (e.g., the same, but identifying different objects in different object stores), the second API call and the fourth API call may be very different, as they are API calls to different object stores in different systems. In this way, a standard set of API calls from the web browser to the objects browser service can be translated into object-store-specific API calls by the objects browser service.

In some implementations, the first object store is S3 compliant and the second object store is not S3 compliant. In some implementations, the first object store is not S3 compliant and the second object store is S3 compliant. In some implementations, both the first object store and the second object store are S3 compliant or not S3 compliant. The objects browser service 110 can translate API calls from the web browser into API calls for a plurality of object stores, S3 compliant or otherwise.

In some implementations, the method 500 includes receiving, from the web browser of the user device, a fifth API call to access a third object in a third object store hosted on a second public cloud and, in response to the fifth API call, making a sixth API call to the third object store to transmit the third object to the user device. The method 500 may include receiving a plurality of API calls from the web browser corresponding to a plurality of object stores. The method 500 may include mapping the plurality of received API calls to API calls compatible with the object stores.

In some implementations, the method 500 includes receiving, from the web browser of the user device, credentials for the first object store, transmitting the credentials to the first object store, and, in response to the first object store validating the user credentials, generating an access token corresponding to the first object store, wherein the first API call includes the access token, and wherein the second API call includes the credentials. In some implementations, the method 500 includes receiving, from the web browser of the user device, credentials for the first object store, transmitting the credentials to the first object store, in response to the first object store validating the user credentials, generating an access token corresponding to the first object store, wherein the first API call includes the access token, and generating a signature based on the credentials, wherein the second API call includes the signature. In some implementations, the method 500 includes storing first credentials for the first object store and second credentials for the second object store. In this way, the web browser does not require entry of the user credentials each time the first object store is to be accessed, and the web browser does not have to store the user credentials. Authenticating the user and generating the access token is discussed in communication sequence 220 of FIG. 2.

It is to be understood that none of the examples provided in this disclosure are intended to limit the scope of the disclosure in any way.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to disclosures containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the disclosure be defined by the claims appended hereto and their equivalents

What is claimed is:

1. A system comprising:
a memory having computer-readable instructions stored thereon; and
a processor of an objects browser service that executes the computer-readable instructions to:
receive, from a web browser of a user device, a first API call to access a first object in a first object store hosted on a public cloud;
in response to the first API call, make a second API call to the first object store to transmit the first object to the user device;
receive, from the web browser of the user device, a third API call to access a second object in a second object store hosted in an on-premises system; and
in response to the third API call, make a fourth API call to the second object store to transmit the second object to the user device.

2. The system of claim 1, wherein the processor executes the computer-readable instructions to:
receive, from the web browser of the user device, a fifth API call to access a third object in a third object store hosted on a second public cloud; and
in response to the fifth API call, make a sixth API call to the third object store to transmit the third object to the user device.

3. The system of claim 1, wherein the processor executes the computer-readable instructions to:
receive, from the first object store, a first API response; and
send the first API response to the web browser of the user device.

4. The system of claim 1, wherein the first object store is S3 compliant and the third object store is not S3 compliant.

5. The system of claim 1, wherein the first API call and the third API include a same header, wherein the first API call includes a payload identifying the first object store, and wherein the third API call includes a payload identifying the second object store.

6. The system of claim 1, wherein the processor executes the instructions to map the first API call to the second API call.

7. The system of claim 1, wherein the processor executes the instructions to map an access token of the first API call to the second API call based on an object store type of the first object store.

8. The system of claim 1, wherein the processor executes the computer-readable instructions to:
receive, from the web browser of the user device, credentials for the first object store;
transmit the credentials to the first object store; and
in response to the first object store validating the user credentials, generate an access token corresponding to the first object store, wherein the first API call includes the access token, and wherein the second API call includes the credentials.

9. The system of claim 1, wherein the processor executes the computer-readable instructions to:
receive, from the web browser of the user device, credentials for the first object store;
transmit the credentials to the first object store;
in response to the first object store validating the user credentials, generate an access token corresponding to the first object store, wherein the first API call includes the access token; and
generate a signature based on the credentials, wherein the second API call includes the signature.

10. The system of claim 1, wherein the processor executes the computer-readable instructions to:
store first credentials for the first object store and second credentials for the second object store.

11. A method comprising:
receiving, from a web browser of a user device, a first API call to access a first object in a first object store hosted on a public cloud;
in response to the first API call, making a second API call to the first object store to transmit the first object to the user device;
receiving, from the web browser of the user device, a third API call to access a second object in a second object store hosted in an on-premises system; and
in response to the third API call, making a fourth API call to the second object store to transmit the second object to the user device.

12. The method of claim 11, further comprising:
receiving, from the web browser of the user device, a fifth API call to access a third object in a third object store hosted on a second public cloud; and
in response to the fifth API call, making a sixth API call to the third object store to transmit the third object to the user device.

13. The method of claim 11, further comprising:
receiving, from the first object store, a first API response; and
sending the first API response to the web browser of the user device.

14. The method of claim 11, wherein the first object store is S3 compliant and the third object store is not S3 compliant.

15. The method of claim 11, wherein the first API call and the third API include a same header, wherein the first API call includes a payload identifying the first object store, and wherein the third API call includes a payload identifying the second object store.

16. The method of claim 11, further comprising mapping the first API call to the second API call.

17. The method of claim 11, further comprising mapping an access token of the first API call to the second API call based on an object store type of the first object store.

18. The method of claim 11, further comprising:
receiving, from the web browser of the user device, credentials for the first object store;
transmitting the credentials to the first object store; and
in response to the first object store validating the user credentials, generating an access token corresponding to the first object store, wherein the first API call includes the access token, and wherein the second API call includes the credentials.

19. The method of claim 11, further comprising:
receiving, from the web browser of the user device, credentials for the first object store;
transmitting the credentials to the first object store;
in response to the first object store validating the user credentials, generating an access token corresponding to the first object store, wherein the first API call includes the access token; and
generating a signature based on the credentials, wherein the second API call includes the signature.

20. The method of claim 11, further comprising:
storing first credentials for the first object store and second credentials for the second object store.
